(19) United States
(12) Patent Application Publication
(10) Pub. No.: US 2007/0147469 A1
(43) Pub. Date: Jun. 28, 2007

(54) Infrared temperature-measuring container stopper and decanter chiller

(76) Inventor: Debra Fogel Harris, Boca Raton, FL (US)

Correspondence Address: JUAN C. VILLAR, 9365 AEGEAN DRIVE, BOCA RATON, FL, 33496, US

(21) Appl. No.: 11/644,265

(22) Filed: Dec. 22, 2006

Related U.S. Application Data
(60) Provisional application No. 60/754,128, filed on Dec. 27, 2005.

(51) Int. Cl. G01J 5/00; G01K 1/14; G01K 1/00

(52) U.S. Cl. 374/121; 374/141; 374/208

(57) ABSTRACT

Disclosed is an IR container stopper comprising a temperature reading display, an infrared detector adapted to drive the display, a window capable of passing infrared radiation to the infrared detector, wherein the window is disposed on a bottom surface of the stopper such as to be directed downward toward the contents of the container when the stopper is placed in an opening of the container.

### PRIOR HISTORY

This patent application claims the benefit of U.S. Provisional Patent Application No. 60/754,128, filed Dec. 27, 2005, the disclosures of which are incorporated by reference herein in their entirety.

### BACKGROUND OF THE DISCLOSURE

1. Field of the Disclosure

This disclosure relates to an infrared container stopper for measuring the temperature of liquid within the container. Also disclosed is a decanter chiller that may be used with the infrared stopper.

2. Discussion of the Related Art

Decanters and the process of decantation are well known in the art, the process being the precipitation of solids from wine, primarily potassium bitartrate. What is not known in the prior art is the measurement and control of the decantation temperature.

### BRIEF DESCRIPTION OF THE DISCLOSURE

Disclosed is an IR container stopper comprising a temperature reading display, an infrared detector adapted to drive the display, a window capable of passing infrared radiation to the infrared detector, wherein the window is disposed on a bottom surface of the stopper such as to be directed downward toward the contents of the container when the stopper is placed in an opening of the container.

Also disclosed is a chiller for a wine decanter for controlling the temperature of wine while measured by the IR stopper.

### BRIEF DESCRIPTION OF THE DRAWINGS

FIG. 1 is a perspective view of a decanter embodiment of the IR stopper of the disclosure.

FIG. 2 is a perspective view of a decanter in the decanter chiller of the disclosure.

FIG. 3 is a perspective view of the IR stopper of FIG. 1 positioned for placement on the decanter.

FIG. 4 is a perspective view of the IR stopper of FIG. 1 inserted into the decanter.

FIG. 5 is a perspective view of another embodiment of the IR stopper.

FIG. 6 is a perspective view of the IR stopper of FIG. 5 inserted into the decanter.

FIG. 7 is a perspective view of a bottle embodiment of the IR stopper of the disclosure.

FIG. 8 is a side view of the IR stopper of FIG. 7 positioned for insertion into a wine bottle.

### DETAILED DESCRIPTION OF THE DISCLOSURE

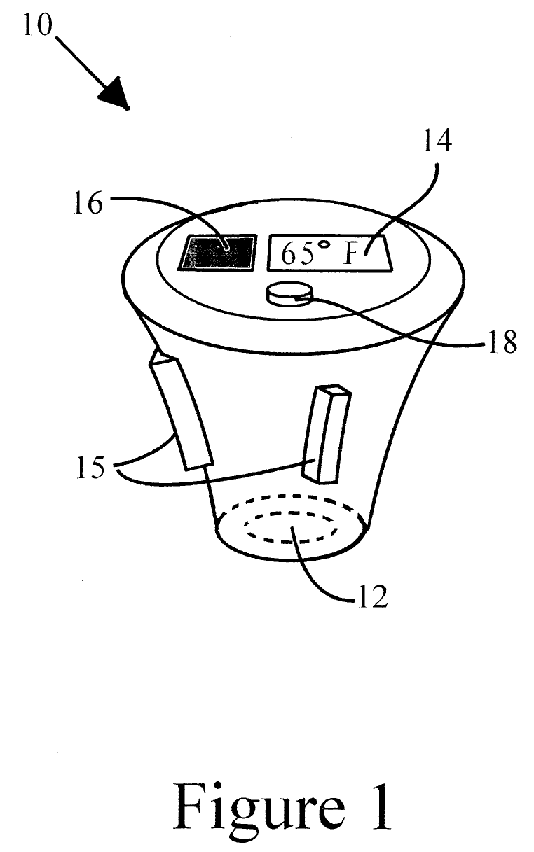

Referring to FIG. 1, there is shown an IR stopper 10 having an IR window 12 for receiving infrared radiation and a digital display 14 for displaying the temperature measured by an IR detector disposed within the stopper. Such IR detectors are well known in the art and are available in exceedingly small sizes. The digital display may be a liquid crystal display (LCD). A photoelectric panel 16 may also be provided to maintain charge on the battery that powers the IR detector.

A power button 18 may be provided to permit shutting the IR detector off in order to save battery power.

A plurality of ribs 15 are provided. The purpose of the ribs is to space the stopper away from the sides of the decanter. This allows air to pass, thus allowing wine in the decanter to breathe during decantation.

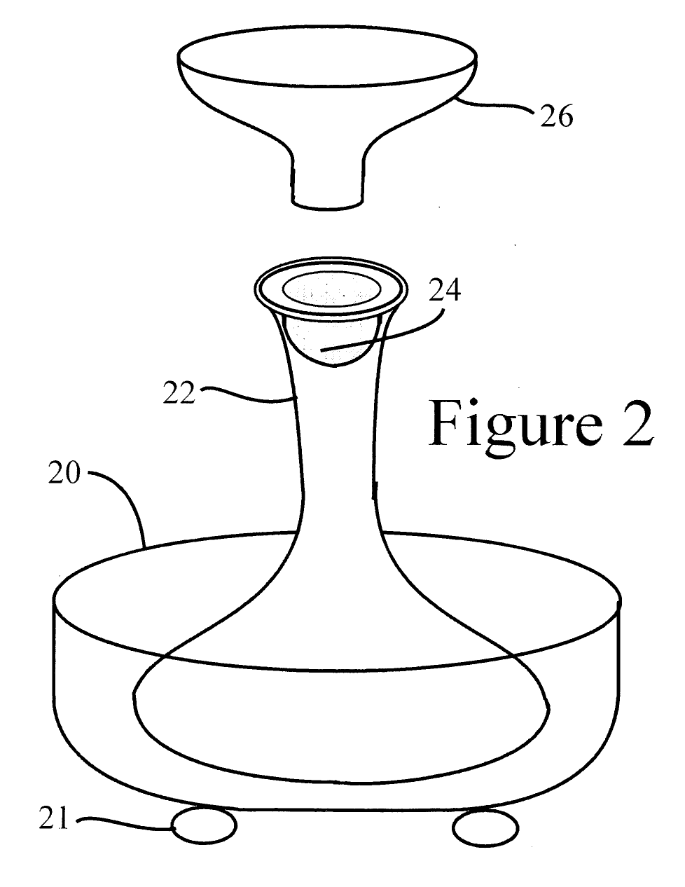

Referring to FIG. 2, there is shown a wine decanter 22 as is well known in the wine art. Typically, a funnel 26 is used to pour an aged wine into the decanter through a strainer 24. The strainer removes the dregs that are a byproduct of fermentation.

Also shown is a decanter chiller 20, in the form of a vessel in which the decanter 22 is placed. The decanter chiller 20 is filled with ice, ice water, or cold water to chill the decanted wine to the optimal temperature for flavor, which will typically be about 65 to 70 degrees Fahrenheit for port, about 60 to 65 F. for red, about 55 to 60 F. for young red, about 50 to 55 F. for white, about 45 to 50 F. for rose, and about 38 to 45 F. for champagne.

Chilling of the wine also accelerates the decantation process wherein precipitate, primarily potassium bitartrate, falls out of solution and settles to the bottom of the decanter, thereby rendering an unclouded product.

It is desirable to know the temperature of the wine to ensure it is not over chilled. Typically, the decanted wine is bottled and then stored at an optimal temperature, but the temperature measuring stopper of this invention now permits direct chilling at the decantering phase.

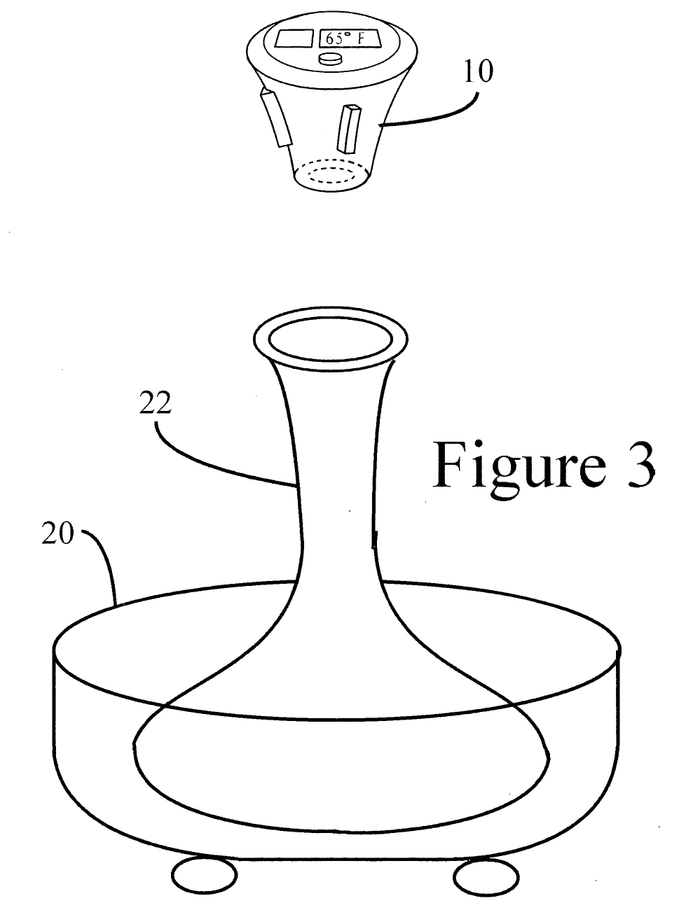

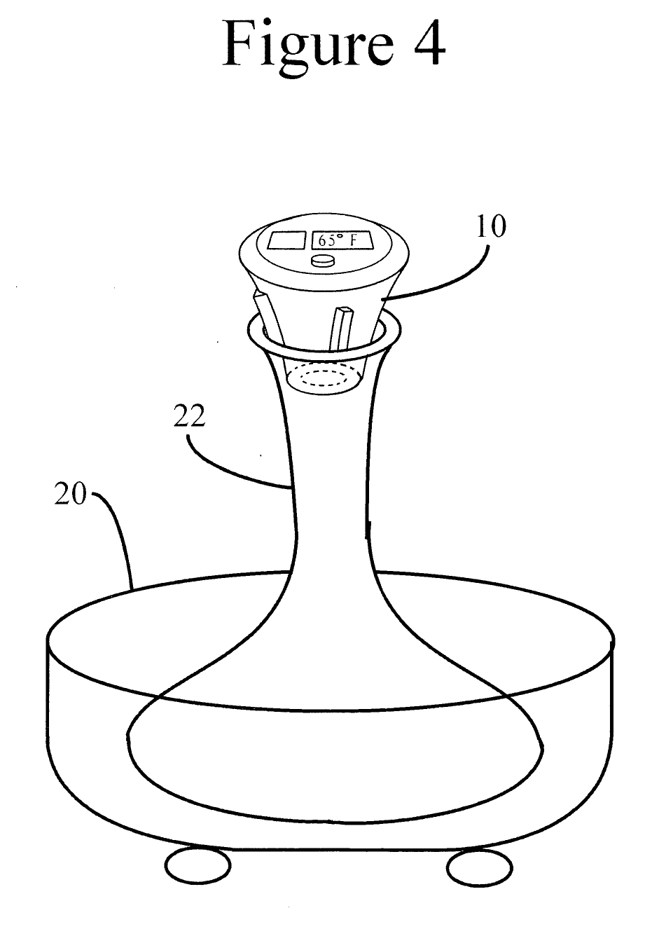

Referring to FIGS. 3 and 4, during decanting the IR stopper 10 is seated into the opening of the decanter 22. The ribs 15 space the stopper away from the sides of the opening so as to allow the wine to breathe. Because the infrared window 12 of the stopper is pointed directly downwards toward the liquid in the decanter 22, it receives the IR radiation emitted by the decanted wine and permits the IR detector within the IR stopper 10 to directly measure the temperature of the decanted wine. The temperature is then displayed to the user in the digital display 14 (See FIG. 1).

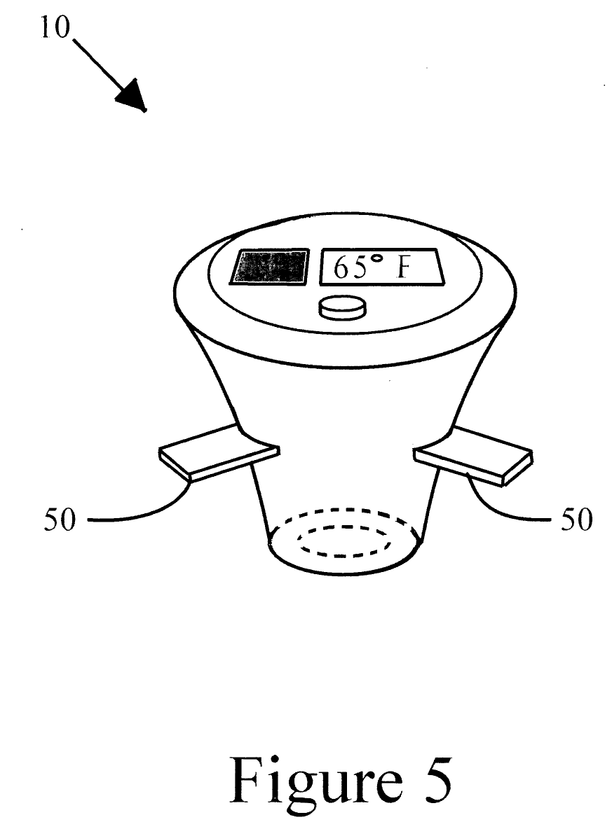

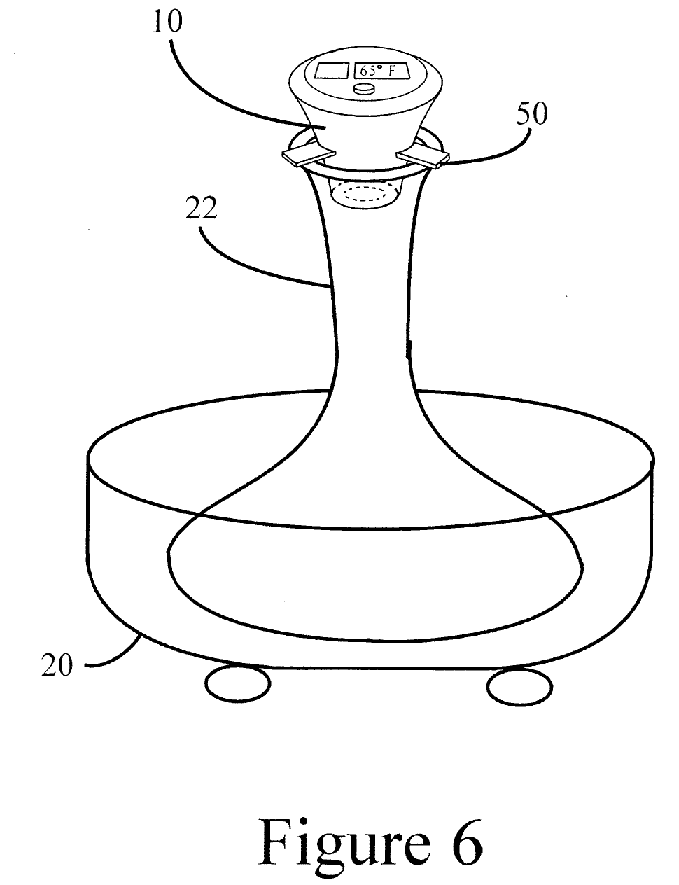

Referring to FIGS. 5 and 6, in another embodiment of the stopper, a plurality of flanges 50 are provided such that the IR stopper is in an elevated position when seated in the opening of the decanter 22. This is an alternative means of providing spacing to permit the decanting wine to breathe during decantation and chilling.

Of course, though the stopper has been shown in use with a decanter, it may be used for any container that contains any liquid.

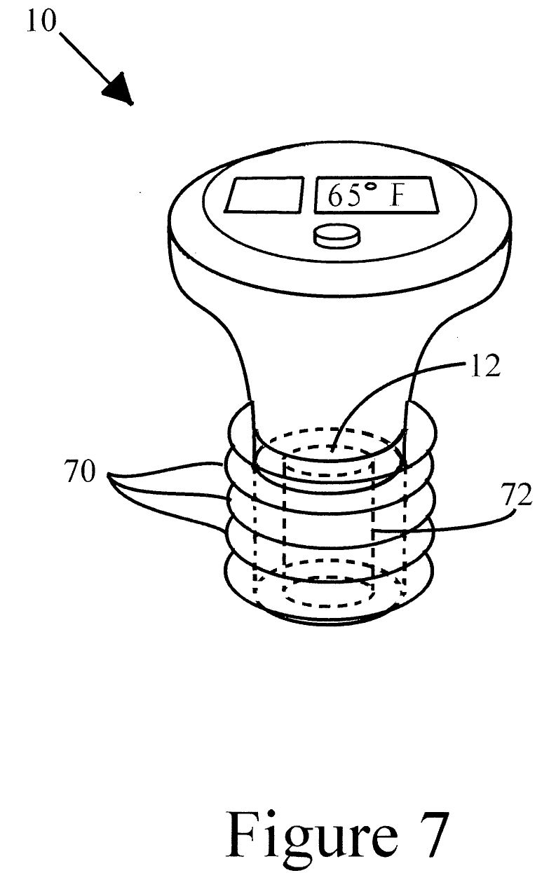

Referring to FIG. 7, there is shown another embodiment of an IR stopper 10 for containers, such as wine bottles. In this embodiment, the neck of the stopper may have flexible sealers 70, such as are typically found on champaign bottle stoppers, for the purpose of “corking” the bottle. With such an IR stopper 10, the temperature of the liquid within the bottle may be constantly monitored. The IR window 12 may be backset such that it receives infrared radiation through an open channel 72. In this manner, the basic unit is not that different from the embodiment of FIG. 1 and thereby aids in the manufacturing process.

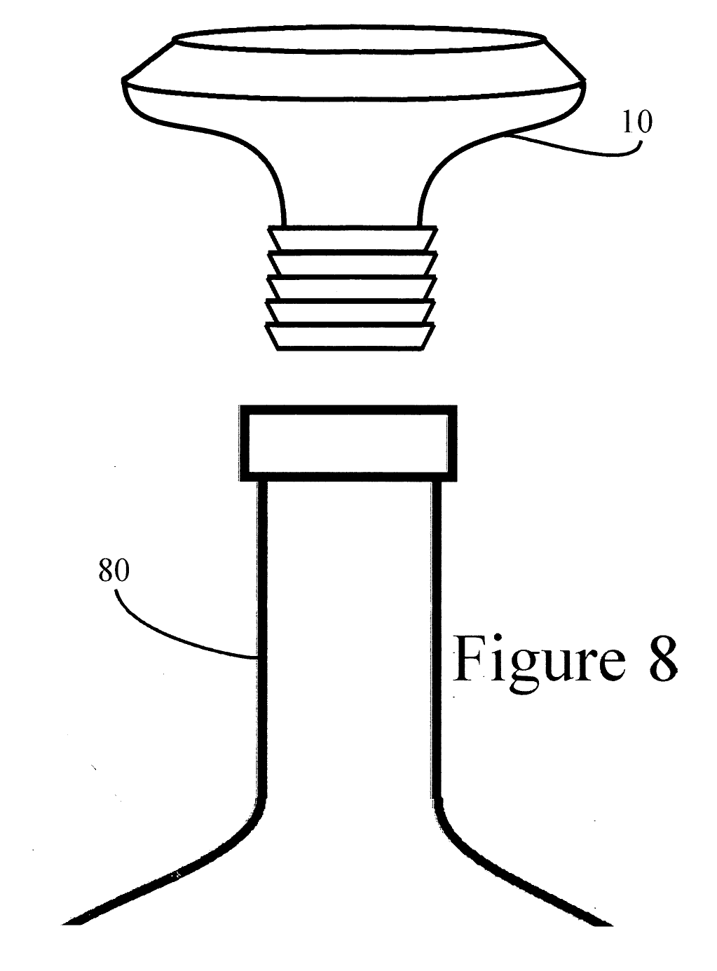

As can be seen in FIG. 8, the bottle stopper embodiment is inserted into a bottle 80 just as a common stopper would be, thereby permitting monitoring on demand of the temperature of the wine in the bottle.

While various values, scalar and otherwise, may be disclosed herein, it is to be understood that these are not exact values, but rather to be interpreted as “about” such values, unless explicitly stated otherwise. Further, the use of a modifier such as “about” or “approximately” in this specification with respect to any value is not to imply that the absence of such a modifier with respect to another value indicates that other value to be exact.

Changes and modifications can be made by those skilled in the art to the embodiments as disclosed herein and such examples, illustrations, and theories are for explanatory purposes and are not intended to limit the scope of the claims. In addition, the Abstract is intended as an aid to search and identify the general field of the invention and is in no way intended to limit the scope of the claims.

What is claimed is:

1. An IR container stopper, comprising:
a temperature reading display;
an infrared detector adapted to drive the display;
a window capable of passing infrared radiation to the infrared detector;
wherein the window is disposed on a bottom surface of the stopper such as to be directed downward toward the contents of the container when the stopper is placed in an opening of the container.

2. A chiller for a wine decanter, comprising a vessel into which the wine decanter is placed and adapted to receive ice water.

3. An IR container stopper and chiller, comprising:
a temperature reading display;
an infrared detector adapted to drive the display;
a window capable of passing infrared radiation to the infrared detector;
wherein the window is disposed on a bottom surface of the stopper such as to be directed downward toward the contents of a wine decanter when the stopper is placed in an opening of the decanter; and
a chiller for the wine decanter, comprising a vessel into which the wine decanter is placed and adapted to receive ice water.
